(19) United States
(12) Patent Application Publication
(10) Pub. No.: US 2007/0129830 A1
(43) Pub. Date: Jun. 7, 2007

(54) PARTS DELIVERY CONTROL SYSTEM

(76) Inventors: Kazuto Kokuryo, Shiga (JP); Shohei Ohara, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/559,471

(22) Filed: Nov. 14, 2006

(30) Foreign Application Priority Data
Nov. 14, 2005 (JP) P2005-329496

(51) Int. Cl. G06F 19/00

(52) U.S. Cl. 700/95

(57) ABSTRACT

The types and sequence of windshields 101 that are to be placed on a delivery pallet 100 are identified based on ordering information of windshields given by a vehicle manufacturer. A worker sequentially places windshields 101 on the delivery pallet 100 according to the ordering information. An IC tag 105 is affixed to each windshield 101 which stores therein information which can identify the type of the windshield 101. By reading the information stored in the windshields 101 by a batch reading unit 50 and an individual reading unit 60, the types and sequence of the windshields 101 placed on the delivery pallet 100 by the worker are grasped, and in the event that an operation error occurs, the worker is informed of the occurrence of such an error.

### BACKGROUND OF THE INVENTION

1. Field of the Invention

The present invention relates to a system for controlling work of placing parts that are to be used on a production line where a plurality of types of products are assembled on a pallet that is to be delivered to the production line.

2. Description of the Related Art

In production of vehicles, there is known a method called a sequential parts pickup method in which necessary parts are picked up from prior assembly stations in the order in which vehicles are assembled (hereinafter, referred to as a sequential parts pickup). For example, JP-A-8-190586 and JP-A-10-244446 describe vehicle productions using the sequential parts pickup.

A number of parts are stored in batch on pallets at prior assembly stations for transfer to post-stations for assembly thereat. A variety of types of parts are placed on a pallet in the order of the sequential parts pickup. Conventionally, this work has been carried out by a pair of workers. For example, one of the pair of workers gives an instruction on which part to be placed on the pallet to the other by designating a part to be placed on the pallet from a list of parts which describes the types and pickup sequence of parts while looking at and reading the list. The other worker picks up the designated parts from the plurality of types of parts and places them on the pallet. Parts that are used according to the sequential parts pickup are arranged on the pallet in the order thereof through repetition of the work by the pair of workers.

The work of arranging a plurality of types of parts on the pallet in the required order demands the workers' intense concentration. Moreover, in a simple work like one in which parts are placed on a pallet, pickup errors or placing errors happen to be made simply by the workers however hard the workers try to concentrate on the work. These errors tend to occur more often as the work continues for a long time. In the event that a placing error of parts is identified in a parts warehouse, wasteful work has to be carried out in which the parts on the pallet are rearranged. For example, in the event that the parts placed on the pallet are identified as being individually wrongly arranged by one position in the order, all the parts on the pallet have to be removed therefrom so as to rearrange them in the correct order on the pallet from the beginning. In addition, in the event that the placing error of parts is not identified in the parts warehouse, so that the pallet is delivered to a vehicle production line, there may be caused a possibility that a smooth operation of the vehicle production line is affected. In particular, in a case where parts to be placed on a pallet are transparent parts such as glass, since it is difficult to identify individual parts from their external appearances, the possibility tends to be increased that parts picking up and placing errors are easily caused.

In addition, conventionally, since the work of placing on a pallet in the order of the sequential part pickup has been carried out by the pair of workers; one gives an instruction on work to be carried out and the other carries out the work as instructed, the labor cost is increased, constituting one of the causes which increase the vehicle production costs.

### SUMMARY OF THE INVENTION

The invention was made in view of these situations, and an object thereof is to provide a technique which can reduce manpower for the work of placing parts necessary for assembly of products on a pallet according to the order of the sequential parts pickup in manufacturing products and the occurrence of the conventional errors during the work.

With a view to attaining the object, according to an aspect of the invention, there is provided a parts delivery control system for controlling work of placing parts required at a production line where a plurality of types of products are assembled on a pallet in the order in which products are assembled, the parts delivery control system including a part sequence identification unit for identifying the sequence and type of a part to be placed on the pallet, a work monitoring unit for identifying the sequence and type of a part that has actually been placed on the pallet by reading data stored in an electronic tag affixed to the part, a determination unit for determining whether or not the sequence and type of a part that has actually been placed on the pallet are appropriate by referring to the sequence and type of the part on the pallet that have been identified by the part sequence identification unit, and a determination result informing unit for informing a determination result of the determination unit.

According to this aspect of the invention, in the work of placing parts necessary for assembly of products on the pallet according to the order of the sequential parts pickup in the manufacturing of products, when an error in placing a correct type of part on the pallet or error in placing a part in the correct order occurs, the error can be identified securely and quickly, so that the worker can be informed of the occurrence of such an error. Since the worker can correct the error of picking up of the wrong part or the like at the site, the manpower for rearranging the parts that have already been placed on the pallet is reduced. In addition, since even though an error is made in the work, the error can be corrected securely and quickly, the metal stress under which the worker is put can be reduced. In addition, by delivering the pallet on which parts are placed as properly as instructed to the products production line where the sequential parts pickup is carried out, the occurrence of a problem that affects the operation of the products production line can be suppressed so as to increase the availability factor of the products production line, and hence, the products production costs can be reduced.

In the aspect of the invention, the work monitoring unit may include an individual reading unit adapted to move relatively along the pallet to read individually data stored in electronic tags of individual parts placed on the pallet. Note that the aspect in which the “individual reading unit moves relatively along the pallet” includes an aspect in which the individual reading unit is moved in such a state that the pallet stays stationary, or, on the contrary to this, an aspect in which the pallet is moved in such a state that the individual reading unit stays stationary.

According to this aspect, the types and sequence of the parts placed on the pallet can be grasped securely and quickly.

In the aspect of the invention, the work monitoring unit may include a batch reading unit which is set in the vicinity of the pallet to read the data stored in the electronic tags of the individual parts placed on the pallet as a batch, and the individual reading unit moves along the pallet to read individually the data stored in the electronic tags of the individual parts placed on the pallet, on condition that the batch reading means confirms that the number of parts placed on the pallet is increased. Note that the batch reading unit may be realized by a batch reading unit which can read the electronic tags of all the parts placed on the pallet at one time. Alternatively, the batch reading unit may be realized by a method of reading the electronic tags of all the parts placed on the pallet in a complementary fashion using a plurality of batch reading units which can each read part of the electronic tags of the parts placed on the pallet at one time.

According to this aspect, in these situations where an additional part is placed on the pallet by the worker, the type and sequence of the part so added can be grasped securely and quickly, whereby whether or not the parts placing work is appropriate can be determined at an appropriate timing according to the parts placing work by the worker.

In the aspect of the invention, the parts delivery control system may include further a work instructing unit for giving an instruction on a type of part to be placed next on the pallet to a worker who is in charge of placing parts sequentially on the pallet.

According to this aspect, since no worker is required who gives an instruction on the type or the like of a part to be placed next on the pallet, the parts placing work can be implemented by a single worker, whereby the labor cost that is incurred in association with the parts placing work can be suppressed.

In the aspect of the invention, metallic plates may be detachably attached to the parts in such a manner as to face the electronic tags.

According to this aspect, the intensity of electric waves radiated from the electronic tags can be enhanced.

In the aspect of the invention, the parts maybe automotive window glasses.

According to this aspect, when delivering automotive window glasses, manpower required for work of placing window glasses on a pallet in the order of a sequential parts pickup adopted can be reduced, and the occurrence of errors during the work can also be reduced.

According to the invention, the manpower required for the work of placing parts necessary for assembly of products on the pallet according to the order of the sequential parts pickup adopted in production of products can be reduced and the occurrence of errors during the work can also be reduced.

### BRIEF DESCRIPTION OF DRAWINGS

FIG. 1 is a diagram showing an overall flow of a parts delivery process to which a parts delivery control system according to an embodiment of the invention is applied.

FIG. 2 is a diagram showing a state in which windshields are placed on a delivery pallet which is going to be delivered to a vehicle production line.

FIG. 3 is a schematic diagram showing the configuration of the parts delivery control system according to the embodiment.

FIG. 4 is a flowchart showing an operation of the parts delivery control system according to the embodiment.

FIG. 5 is a diagram showing a setting example of batch reading units.

FIG. 6 is a table showing an example of windshield ID's which are read by the pair of batch reading units.

FIG. 7 is a diagram showing an IC tag attachment which can be detachably attached to a windshield.

FIG. 8 is a configuration for enhancing the intensity of electric waves that are transmitted and received by an IC tag affixed to the windshield.

### DESCRIPTION OF THE PREFERRED EMBODIMENTS

Hereinafter, embodiments of the invention will be described by reference to the accompanying drawings.

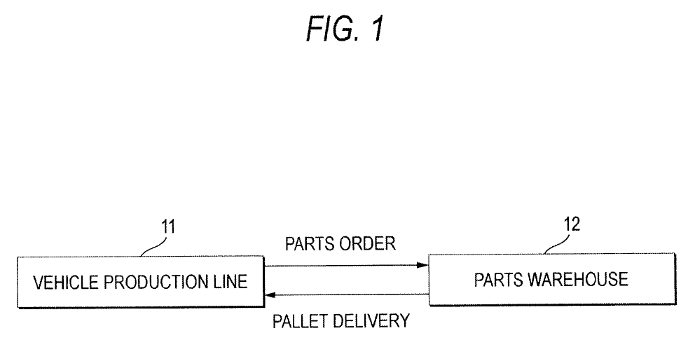

FIG. 1 is a diagram showing an overall flow of a parts delivery process to which a parts delivery control system according to an embodiment of the invention is applied. Note that while in the following description, windscreens will be taken as an example of parts to be delivered to vehicle manufacturers, parts to be delivered to vehicle manufacturers are not limited to windshields. For example, parts to be delivered to vehicle manufacturers may be rear window glasses, side window glasses or the like may. Furthermore, any of windscreens, rear window glasses and side window glasses may take a form of an assembly of parts in which other component parts such as a mirror base, antenna and the like maybe assembled on to the glass. In addition, parts to be delivered to vehicle manufacturers may be a set of parts made up of a windshield and a rear window glass.

In a vehicle production line 11 of a vehicle manufacturer, vehicles of a variety of model lines are assembled sequentially. In the following description, a process in which parts are collected or picked up in the order in which vehicles are assembled on the vehicle production line 11 is referred to as a sequential parts pickup. A vehicle manufacturer places an order for windshields necessary for production of vehicles on the vehicle production line 11 with a glass manufacturer. As this occurs, types and pickup sequence of windshields are designated according to a sequential parts pickup adopted on the vehicle production line 11. A plurality of types of windshields are installed by type on pallets allocated by type for storage in a parts warehouse 12 of the glass manufacturer. In the parts warehouse 12, work is performed of placing windshields ordered by the vehicle manufacturer on a pallet according to the order of the sequential parts pickup adopted on the vehicle production line 11. The pallet on which the placement of ordered windshields is completed is then delivered to the vehicle production line 11. On the vehicle production line 11, the windshields placed on the pallet are assembled to vehicles in the predetermined order.

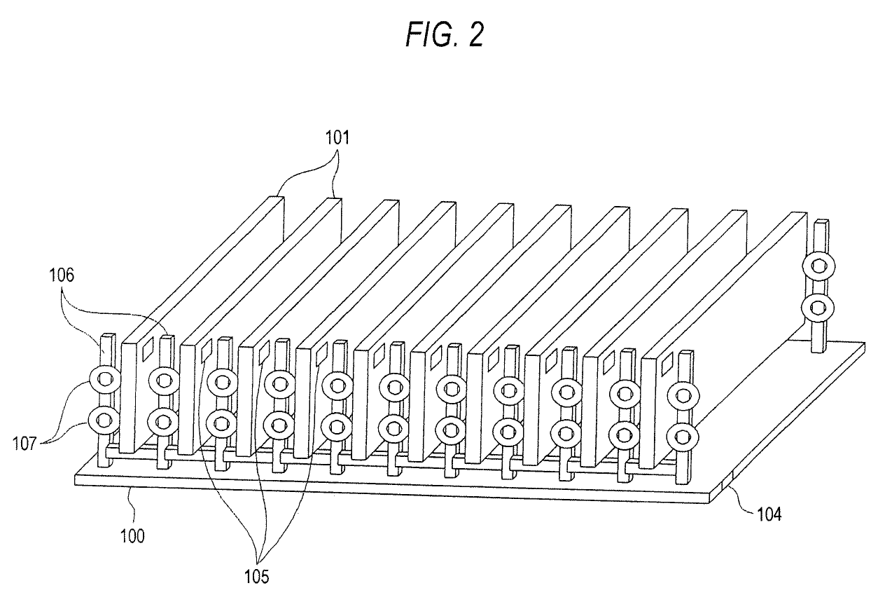

FIG. 2 shows a state in which windshields 101 are placed on a delivery pallet 100 which is to be delivered to the vehicle production line 11. A radio frequency identification tag (hereinafter, referred to as an IC tag) 104 is affixed to the delivery pallet 100. A pallet ID for identifying the delivery pallet 100 is stored in the IC tag 104 as data. Partition members 106 are provided on the delivery pallet 100 for installation of windshields 101. Damper members 107 each made of an elastic material such as a rubber are mounted on the partition members 16 for protecting the windshields 101 so placed on the pallet 100. A plurality of types of windshields 101 re placed between the partition members 106 according to the order of the sequential parts pickup on the vehicle production line. An IC tag 105 is affixed to each windshield 101 which stores therein a windshield ID for identifying the relevant windshield 101.

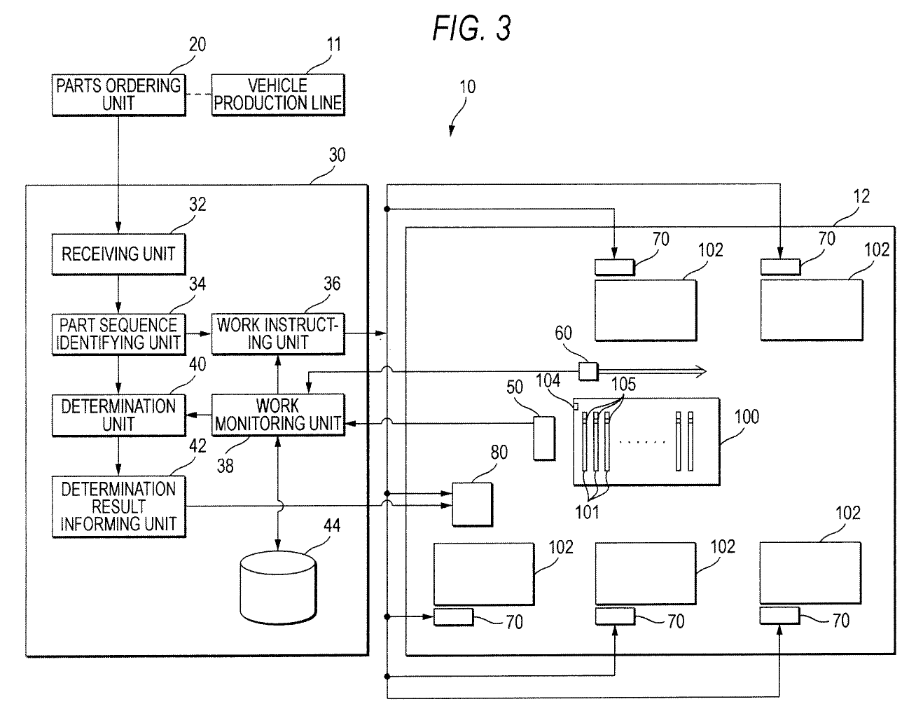

FIG. 3 is a schematic diagram showing the configuration of a parts delivery control system 10 according this embodiment. In the event of delivering windshields necessary for assembly of vehicles from the parts warehouse to the vehicle manufacturer, the parts delivery control system 10 controls work of placing windshields on a delivery pallet that is delivered to the vehicle manufacturer in the order of the sequential parts pickup adopted on the vehicle production line.

The parts delivery control system 10 includes a parts ordering unit 20, a delivery control unit 30, a batch reading unit 50, an individual reading unit 60, an instructing unit 70 and a display unit 80. The parts ordering unit 20 and the delivery control unit 30 are connected to each other by way of a LAN (Local Area Network) in such a manner as to enable a communication therebetween. The parts ordering unit 20 and the delivery control unit 30 each have computer devices including a CPU, a keyboard and an input/output unit such as a mouse as a hardware configuration and a computer program and the like as a software configuration. In FIG. 3, functional blocks are described which are realized by virtue of a cooperation between the hardware configuration and the software configuration.

The parts ordering unit 20 sends out order information which indicates types and pickup sequence of windshields which are to be delivered on pallets to the delivery control unit 30 based on a vehicle production plan made by the vehicle manufacturer.

The delivery control unit 30 includes a receiving unit 32, a part sequence identifying unit 34, a work instructing unit 36, a work monitoring unit 38, a determination unit 40, a determination result informing unit 42 and a pallet information storage unit 44. The delivery control system 30 may be provided within the parts warehouse 12 or a place outside the parts warehouse 12 such as a centralized control center.

The receiving unit 32 receives ordering information sent out from the parts ordering unit 20 via the LAN.

The part sequence identifying unit 34 identifies the type and pickup sequence of a windshield that is to be placed on the delivery pallet 100 which is going to be delivered to the vehicle production line 11.

The work instructing unit 36 gives the worker an instruction on a type of a part that is to be placed on the delivery pallet 100 based on the types and sequence of parts identified by the part sequence identifying unit 34 and the types and sequence of parts that have actually been placed on the delivery pallet 100 which has been identified by the work monitoring unit 38, which will be described later on. Work instructions given by the work instructing unit 36 are transmitted to workers by utilizing the display unit 80 and lighting an instructing unit 70 such as LED's which are provided in the vicinity of pallets arranged by type. In addition to this, the work instructing unit 36 causes information necessary for the work of placing windshields 101 on the delivery pallet 100 to be displayed on the display unit 80.

The work monitoring unit 38 monitors work in which a delivery pallet 100 is placed in a predetermined position by the worker using the batch reading unit 50. Furthermore, the work monitoring unit 38 identifies the types and sequence of windshields which are actually placed on the delivery pallet 100 based on data inputted from the batch reading unit 50 and the individual reading unit 60. A method will be described later on which identifies the types and sequence of windshields which are actually placed on the delivery pallet 100.

The determination unit 40 determines whether or not the delivery pallet 100 which is placed in the predetermined position accommodates a number of windshields which is designated in the order information. Furthermore, the determination unit 40 determines whether or not the types and sequence of the windshields placed on the delivery unit 100 are proper by comparing the types and sequence of windshields to be placed on the delivery pallet 100 which have been identified by the part sequence identifying unit 34 with the types and sequence of the windshields actually placed on the delivery pallet 100 which have been identified by the work monitoring unit 38.

The determination result informing unit 42 informs the worker of the result of a determination by the determination unit 40. To be specific, the determination result informing unit 42 causes the display unit 80 to display thereon the result of a determination by the determination unit 40. For example, in the event that an erroneous arrangement of windshields is determined to occur on the delivery pallet 100, a warning sentence such as saying, “the type of an Xth windshield is wrong.” is displayed on the display unit. The determination result informing unit 42 may use a sound output unit in combination with the display unit 80 or alone as a substitute for the display unit 80, so as to produce a sound output such as an alarm when such an erroneous arrangement is found.

The pallet information storage unit 44 stores therein information such as on the number of windshields that can be accommodated on a delivery pallet 100, the size of a delivery pallet 100, windshield installation positions on a delivery pallet and the like while relating these pieces of information to a pallet ID which identifies a delivery pallet 100.

The batch reading unit 50 is fixed in the vicinity of a delivery pallet 100 which is placed in the predetermined position. The batch reading unit 50 receives electric waves from an IC tag 105 affixed to a windshield 101 placed on the delivery pallet 100 so as to read data stored in the IC tag 105. Historical data related to a windshield 101 including a windshield ID which identifies each windshield 101, the type of glass used, its production date and the like is stored in an IC tag 105 for a windshield 101. IC tags 105 affixed to windshields 101 placed on a delivery pallet 100 are read as a batch by the batch reading unit 50. Namely, although the sequence of positions of windshields 101 placed on a delivery pallet 100 is not identified by the batch reading unit 50, the number of windshields 101 placed on a delivery pallet 100 can be grasped by information stored in individual IC tags 105 to which unique ID's are allocated.

In addition, the batch reading unit 50 reads information stored in an IC tag 104 affixed to a delivery pallet 100 which is placed in the predetermined position. A pallet ID is stored in an IC tag 104 for a delivery pallet 100 which identifies the delivery pallet 100.

The individual reading unit 60 is movably placed in the vicinity of the predetermined position where a delivery pallet 100 is placed. The individual reading unit 60 is allowed to move by a mechanism which can move along a delivery pallet 100 placed in the predetermined position in a direction in which windshields are stacked on the delivery pallet 100. By moving along the delivery pallet 100, the individual reading unit 60 verifies the positions and sequence of the individual windshields 101 on the delivery pallet 100 and individually reads IC tags 105 which are affixed to the windshields 101.

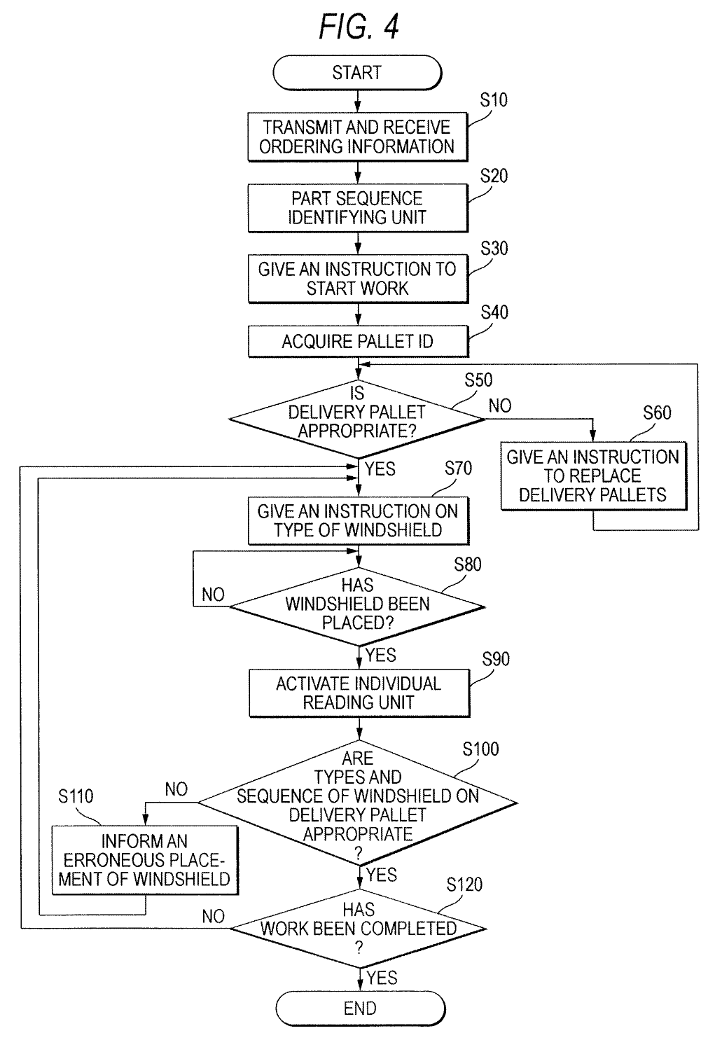

FIG. 4 is a flowchart which shows an operation of the parts delivery control system 10 according to this embodiment. Firstly, information on an order of windshields is transmitted from the parts ordering unit 20 to the delivery control unit 30, and the delivery control unit 30 receives the windshield order information (S10).

The delivery control unit 30 identifies types and sequence of windshields which are to be placed on a delivery pallet 100 which is going to be delivered to the vehicle production line 11 based on the order information (S20). For example, in the event that the delivery pallet 100 can accommodate 40 windshields thereon, the installation sequence and types of windshields to be placed on the delivery pallet 100 are related to each other in such a way that first is type A, second is type B, third is type A, . . . .

After the types and sequence of windshields which are to be placed on the delivery pallet 100 are identified, an initiation of windshield loading work is displayed on the display unit (S30). Information is displayed on the display unit 80 which is related to the number of windshields that can be accommodated on the delivery pallet 100 which is used for the windshield loading work and the types and sequence of windshields 101 that are to be placed on the delivery pallet 100. When the delivery pallet 100 is placed in the predetermined position by the worker, a pallet ID stored in an IC tag 104 affixed to the delivery pallet 100 is read by the batch reading unit 50 (S40). The determination unit 40 collates with the pallet information storage unit 44 using the pallet ID read by the batch reading unit 50 as a reference key, so as to acquire the number of windshields that can be accommodated on the delivery pallet 100. The determination unit 40 checks on the appropriateness of the delivery pallet by determining whether or not the number of windshields that can be accommodated on the delivery pallet 100 satisfies the number of windshields designated in the order information (S50). If the number of windshields that can be accommodated on the delivery pallet 100 does not satisfy the number of windshields designated in the order information (if N in S50), the worker is informed that the wrong delivery pallet 100 is being placed in the predetermined position and is given an instruction to replace the wrong delivery pallet 100 with a proper one (S60).

If the number of windshields that can be accommodated on the delivery pallet 100 satisfies the number of windshields designated in the order information (if Y in S50), types of windshields 101 that are to be placed on the delivery pallet 100 are instructed using the instructing unit 70 and the display unit 80 (S70).

By instructing the worker on the types of windshields that are to be placed next on the delivery pallet 100 using the instructing unit 70 and the display unit 80 in this way, the erroneous placement of windshields 101 on the delivery pallet 100 by the worker can be suppressed in an ensured fashion. In addition, the windshields placing work can be implemented by only the worker who is in charge of the windshields placing work without needing no worker who instructs the work, whereby the labor cost incurred for the windshields placing work can be suppressed.

Following this, the installation conditions of the windshields 101 so placed on the delivery pallet 100 are monitored using the batch reading unit 50, and whether or not an additional windshield 101 has been placed is determined (S80). To be specific, information stored in IC tags 105 affixed to the windshields 101 placed on the delivery pallet 100 is read regularly by the batch reading unit 50, whereby the number of windshields 101 placed on the delivery pallet 100 is grasped. Here, if the number of windshields 101 that has been identified by the batch reading unit 50 is increased, it is determined that an additional windshield 101 has been installed on the delivery pallet 100.

If it is determined that the additional windshield 101 has been installed on the delivery pallet 100 (if Y in S80), the individual reading unit 60 is caused to move along the direction in which the windshields are stacked on the delivery pallet 100, so as to read sequentially information stored in the IC tags affixed to the individual windshields 101 (S90). The information of the IC tags so read by the individual reading unit 60 is then sequentially transmitted to the work monitoring unit 38. As this occurs, the work monitoring unit 38 relates each windshield to its type and refers to a parts data base (not shown) stored therein, so as to identify types that correspond to the windshields 101 placed on the delivery pallet 100 based on the windshield ID's that have been read by the individual reading unit 60, whereby the types and sequence of the windshields 101 placed on the delivery pallet 100 are grasped. On the other hand, if it is determined that no additional windshield has been installed on the delivery pallet 100 (if N in S80), the flow returns to the process in S80.

The determination unit 40 determines whether or not proper types of windshields 101 are placed in a proper sequence on the delivery pallet 100 by comparing the types and sequence of the windshields 101 which are placed on the delivery pallet 100 with the types of sequence of the windshields described in the order information (S100).

In the event that the placement of the additional windshield 101 on the delivery pallet 100 by the worker is detected using the batch reading unit 50 in this way, the types and sequence of the windshields 101 placed on the delivery pallet 100 are grasped securely and quickly using the individual reading unit 60, whereby whether or not the windshields placing work is appropriate can be determined at an appropriate timing according to the windshields placing work by the worker.

If the types and sequence of the windshields 101 placed on the delivery pallet 100 are not appropriate (if N in S100), the worker is informed of the occurrence of an erroneous placement of the windshields by means of characters or an image of the display unit 80 or a sound emitted from a speaker. For example, if it is determined that the sequence of the windshields 101 placed on the delivery pallet 100 is different from the sequence of the windshields described in the order information, information by means of characters such assaying, “a placement error has occurred.” is displayed on the display, or a warning sound such as an alarm is produced, so that the worker is caused to recognize the occurrence of the erroneous placement and is then urged to correct the erroneous placement of the windshields. After the windshield erroneous placement has been informed, the flow returns to S70, where an instruction on the type of a windshield that is to be placed next is given in such a state that the erroneously placed windshield has been removed.

On the contrary, if it is determined that the types and sequence of the windshields 101 placed on the delivery pallet 100 are appropriate (if Y in S100), it is then determined that whether or not the work of placing the windshields 101 on the delivery pallet 100 has been completed by investigating whether or not the number of the windshields 101 which are appropriately placed on the delivery pallet 100 has reached the target number (S120). If it is determined that the work of placing the windshields 101 on the delivery pallet 100 has not yet been completed (if N in S120), the flow returns to S70, where an instruction on the type of a windshield that is to be placed next is given. On the contrary, if it is determined that the work of placing the windshields 101 on the delivery pallet 100 has been completed (if Y in S120), the process herein ends.

According to the parts delivery control system that has been described heretofore, in the work in which windshields which are necessary for assemblage of products are placed on a delivery pallet in the order in which the sequential parts pickup adopted on the vehicle production line, in the event that an error occurs of placing a wrong type of windshield on the delivery pallet or placing a windshield on the delivery pallet in a wrong order, the error can be identified securely and quickly so as to inform the worker of the occurrence of the error. Since the worker can correct the placement of the wrong type of windshield at the site, the manpower required for the rearrangement of the windshields placed on the delivery pallet is reduced. In addition, since even though an error in performing the work occurs, the error can be corrected securely and quickly, the mental stress under which the worker is put is reduced. Furthermore, by ensuring the delivery of the delivery pallet on which the windshields are placed as instructed to the vehicle production line where the sequential parts pickup is carried out, the occurrence of a problem that affects the operation of the vehicle production line can be suppressed, so as to increase the availability factor of the vehicle production line, which leads to a reduction in the vehicle production costs in the end.

(Placing Mode of Batch Reading Unit)

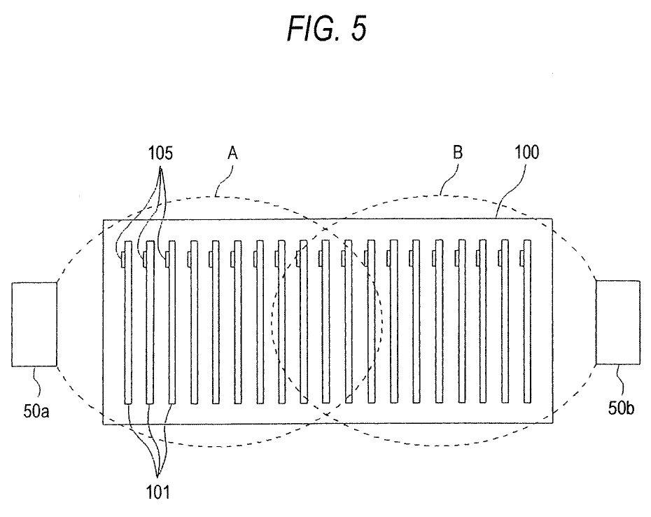

While in the embodiment that has been described above, all the IC tags affixed to the windshields placed on the delivery pallet are read by the single batch reading unit, in the event that a reachable distance of electric waves from the IC tags becomes insufficient because of the size of the delivery pallet, two or more batch reading units may be provided. FIG. 5 shown an setting example of batch reading units. In this example, a batch reading unit 50a and a batch reading unit 50b are set on both sides of a delivery pallet 100, respectively. An area surrounded by a dotted line A denotes a range of IC tags that can be read by the batch reading unit 50a. Similarly, an area B surrounded by a dotted line B denotes a range of IC tags that can be read by the batch reading unit 50b. As shown in the figure, information stored in IC tags 105 affixed to all windshields that are placed on the delivery pallet 100 cannot be read by only the batch reading unit 50a or the batch reading unit 50b. As is shown in FIG. 5, however, by causing the readable range by the batch reading unit 50a to partially overlap the readable range by the batch reading unit 50b, information stored in the IC tags 105 affixed to all the windshields 101 placed on the delivery pallet 100 can be read.

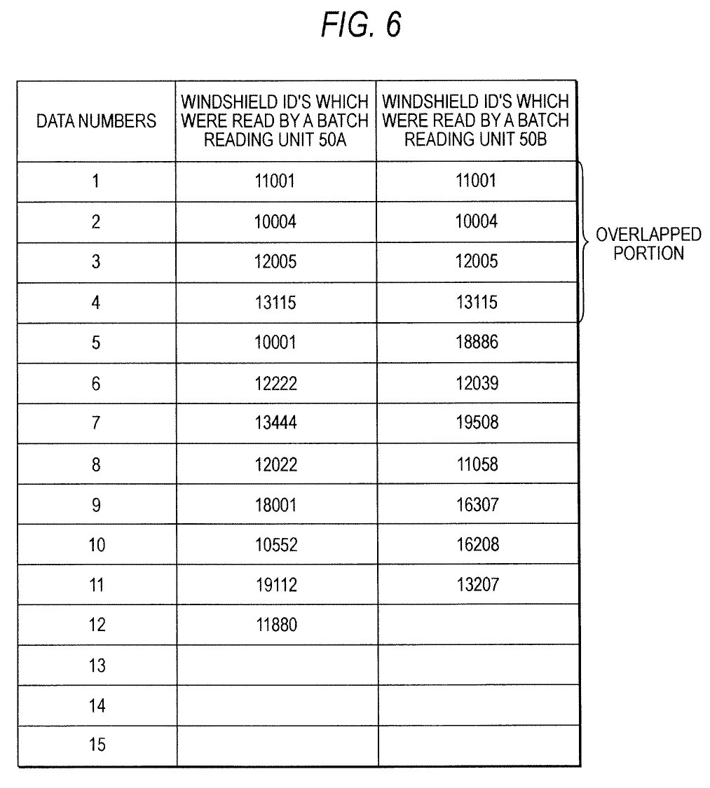

FIG. 6 shows an example of windshield ID's read by the batch reading unit 50a and the batch reading unit 50b. 12 windshield ID's in total were read by the batch reading unit 50a, while 11 windshield ID's in total were read by the batch reading unit 50b. Data numbers 1 to 4 denote windshield ID's which were read equally by the batch reading unit 50a and the batch reading unit 50b. This shows a fact that the windshields 101 to which the windshield ID's denoted by the data numbers 1 to 4 were affixed existed in the portion where the readable range by the batch reading unit 50a overlapped the readable range by the batch reading unit 50b. Namely, it is found that the total of the windshields 101 placed on the delivery pallet 100 is 12+11−4=19 (pieces).

(Affixing Mode of IC Tags)

In the event that a windshield is a laminated glass in which a sheet-like intermediate film is interposed between a pair of sheets of glass, an IC tag can be affixed to the windshield by embedding the IC tag in the intermediate film. In addition, in the event that a windshield is a single tempered glass, an IC tag an be affixed to the windshield by bonding the IC tag on to one side of the windshield.

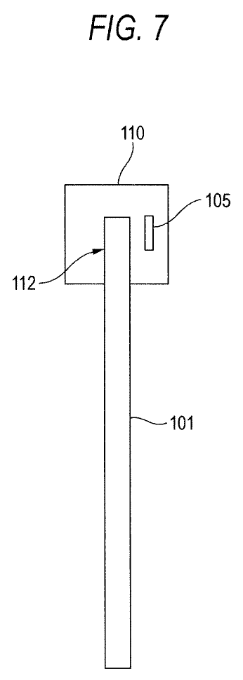

The IC tag 105 may not be affixed directly to the windshield 101. For example, the IC tag 105 can be affixed to the windshield 101 by mounting a detachable IC tag attachment 110 as shown in FIG. 7. The IC tag attachment 110 does not interrupt electric waves that are transmitted and received by the IC tag 105 and is formed from a material such as a resin which has a certain flexibility. By imparting the flexibility to the IC tag attachment 110, when the windshield 101 is placed on the delivery pallet, a damage that would be caused by a contact with an adjacent windshield can be suppressed. The IC tag 105 which is used to identify the windshield 100 is embedded in the IC tag attachment 110. The IC tag attachment 110 has a cutout portion 112 into which an upper portion or a side portion of the windshield 100 can be inserted. By adopting the configuration like this, the IC tag attachment 110 can be detachably attached to the windshield 101, and hence, the IC tag attachment 110 can be attached to the windshield 101 when it becomes necessary in the parts delivery control system. In addition, by using a rewritable IC tag as the IC tag 105 embedded in the IC tag attachment 110, the windshield ID and historical information which are stored in the IC tag 105 can be rewritten according to a type of windshield 101 to which the IC tag attachment 110 is attached, whereby the IC tag attachment 110 can be used on windshields repeatedly.

(Means for Enhancing the Intensity of Electric Wave from IC Tag)

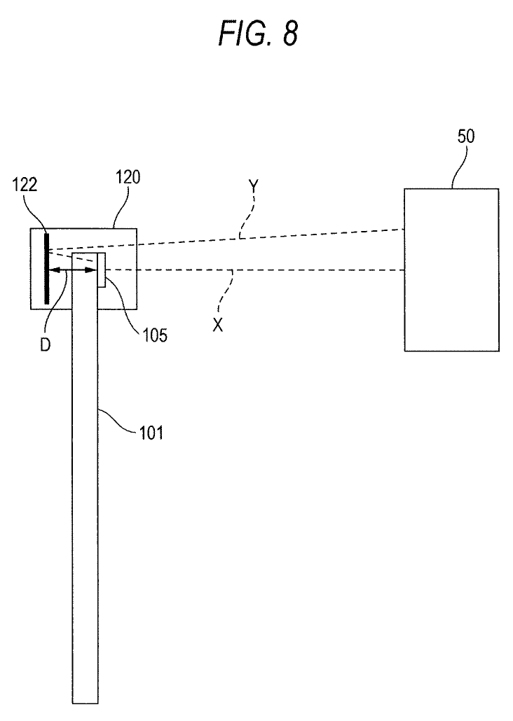

A means or unit will be described which enhances the intensity of an electric wave that is transmitted and received by an IC tag 105 affixed to each windshield 101. FIG. 8 shows a configuration for enhancing the intensity of electric waves that are transmitted and received by an IC tag 105 that is affixed to a windshield 101. An electric wave intensity enhancing attachment 120 is attached to the windshield 101. The electric wave intensity enhancing attachment 120 does not interrupt electric waves that are transmitted and received by the IC tag 105 and is formed from a material such as a resin having a certain flexibility. In the electric wave intensity enhancing attachment 120, a metallic plate 122 is embedded on an opposite side to a side where the IC tag 105 is bonded in such a manner as to face the IC tag 105, whereby by providing a batch reading unit 50 is provided on a front surface side of the IC tag 105, electric waves that are transmitted and received between the IC tag 105 and the batch reading unit 50 are allowed to contain not only a component X which is propagated directly between the IC tag 105 and the batch reading unit 50 but also a component Y which enters and exits from a rear surface side of the IC tag 105 and are then reflected on the metallic plate 122 so as to reach the batch reading unit 50. By enhancing the intensity of the electric waves that are transmitted and received by the IC tag 105 in this way, a distance between the IC tag 105 and the batch reading unit 50 which can communicate with the IC tag 105 can be increased without using special equipment and at low costs. As a result, the single batch reading unit 50 is allowed to communicate with IC tags 105 which are affixed to more windshields. In addition, by setting a distance D between the IC tag 105 and the metallic plate 122 depending on the frequency of an electric wave that is used on the IC tag 105, the intensity of electric waves can be intensified which are transmitted and received between the IC tag 105 and the batch reading unit 50.

The invention is not limited to the embodiments, and hence, various modifications including design changes cam be made based on the knowledge of those skilled in the art to which the invention pertains, and embodiments to which such modifications are applied are understood to be included in the scope of the invention.

While in the embodiments that have been described above, the timing when the individual reading unit 60 reads the IC tags 105 affixed to the windshields 101 placed on the delivery pallet 100 coincides with when the additional windshield 101 is determined to have been installed on the delivery pallet 100, the timing when the individual reading unit 60 reads the IC tags 105 is not limited to that timing. For example, the IC tag reading timing of the individual reading unit 60 may be set to be triggered on condition that the number of windshields 101 placed on the delivery pallet 100 which is grasped by the batch reading unit 50 coincides with the number of ordered windshields which is written in the order information.

What is claimed is:

1. A parts delivery control system for controlling work of placing parts required at a production line where a plurality of types of products are assembled on a pallet in the order in which products are assembled, the parts delivery control system comprising:
a part sequence identification unit for identifying the sequence and type of a part to be placed on the pallet;
a work monitor for identifying the sequence and type of a part that has actually been placed on the pallet by reading data stored in an electronic tag affixed to the part;
a determination unit for determining whether or not the sequence and type of a part that has actually been placed on the pallet are appropriate by referring to the sequence and type of the part on the pallet that have been identified by the part sequence identification unit; and
a determination result informing unit for informing a determination result of the determination unit.

2. The parts delivery control system as set forth in claim 1, wherein the work monitor includes an individual reader adapted to move relatively along the pallet to read individually data stored in electronic tags of individual parts placed on the pallet.

3. The parts delivery control system as set forth in claim 2, wherein the work monitor includes a batch reader which is set in the vicinity of the pallet to read the data stored in the electronic tags of the individual parts placed on the pallet as a batch, and wherein the individual reader moves along the pallet to read individually the data stored in the electronic tags of the individual parts placed on the pallet, on condition that the batch reader confirms that the number of parts placed on the pallet is increased.

4. The parts delivery control system as set forth in claim 1, further comprising:
a work instructing unit for giving an instruction on a type of part to be placed next on the pallet to a worker who is in charge of placing parts sequentially on the pallet.

5. The parts delivery control system as set forth in claim 1, wherein metallic plates are detachably attached to the parts in such a manner as to face the electronic tags.

6. The parts delivery control system as set forth in claim 1, wherein the parts are automotive window glasses.
